(19) United States
(12) Patent Application Publication
(10) Pub. No.: US 2023/0325907 A1
(43) Pub. Date: Oct. 12, 2023

(54) REDUCING A NUMBER OF SELECTABLE ITEMS TO AN ULTIMATE WINNER

(71) Applicant: WILD ALMONDS, LLC., MILL CREEK, WA (US)

(72) Inventor: ANDREW REID, MILL CREEK, WA (US)

(21) Appl. No.: 18/022,368

(22) PCT Filed: Aug. 23, 2021
(86) PCT No.: PCT/US2021/047197

§ 371 Date: Feb. 21, 2023

Related U.S. Application Data
(60) Provisional application No. 63/068,895, filed on Aug. 21, 2020.

(51) Int. Cl. G06Q 30/0601

(52) U.S. Cl. CPC G06Q 30/0641; G06Q 30/0625

(57) ABSTRACT

A method of conducting a contest includes compiling identifiers of a first set of multiple items, each item of the first set having at least one characteristic different from each other item of the first set, making a graphical user interface (GUI) available to display devices of multiple user participants, the GUI including the identifiers of the multiple items, receiving from each of the user participants via the GUI an indication of the preference of each user participant for an item of the first set, and tallying the user indications to determine a first subset of one or more victorious set items of a first round of the contest, the first subset containing fewer items than does the first set.

### PRIORITY CLAIM

This application claims priority to U.S. Provisional Patent Application Ser. No. 63/068,895 filed Aug. 21, 2020, and PCT/US2021/47197 filed Aug. 23, 2021, the contents of which are hereby incorporated by reference in their entirety as if fully set forth herein.

### BACKGROUND

Often users of the internet need to search several resources or URL addresses to compare items. Engagement can be low between the searcher and the item online. Reviews are used to learn more about items or products where available with varying degrees of engagement and reliability. The same can be said for a large number of items offline.

### BRIEF DESCRIPTION OF THE DRAWINGS

FIG. 1 illustrates an example of how the divisions may be separated by the server for the purpose of display to the end user according to an embodiment.

FIG. 2 illustrates how the group display is compiled based on the configuration provided by the tournament owner according to an embodiment.

FIG. 3 illustrates how participants assign values to selectable items according to an embodiment.

FIG. 4 illustrates how selectable items advance within a stage/round/stage according to an embodiment.

FIG. 5 illustrates how a layout of the interface is projected to be displayed according to an embodiment.

FIGS. 6A-6B illustrate the relationship between child events and parent events according to an embodiment.

FIG. 7 illustrates how scores are determined according to an embodiment.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

Embodiments of the present invention relate to systems and methods for conducting on-line events wherein participants award points to selectable items such as, for example, wines that are assigned to divisions and possibly groups.

An embodiment allows for visualization of like items in a central location. Benefit is obtained for the item as participants are providing feedback about the ranking they give. Participants are able to reduce a large number of items to a smaller list matching their tastes. Participants also see how their preferences match with other participants in their parent and child event. Those creators or vested interest owners of selectable items are able to obtain ratings for their objects when they are presented with objects of a like kind.

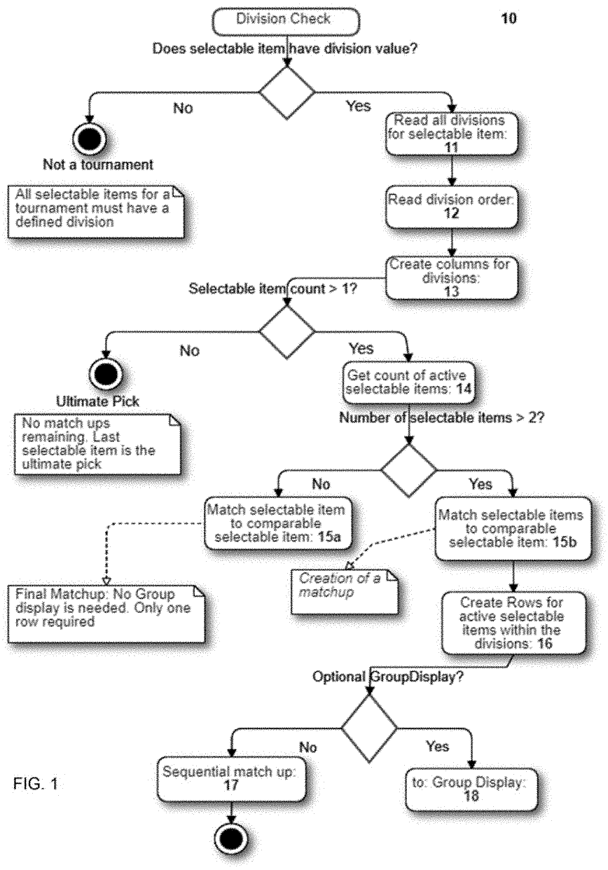

FIG. 1 illustrates a division layout process 10 according to an embodiment. As shown, the server provides a check per selectable item for the presence of a division/category. If division/category exists, it is read for active squares/selectable items at step 11. If division/category does not exist, then no tournament will be conducted. The order of the divisions for display, and how matchups are established is provided at step 12. The number of divisions dictates the number of columns needed for display and created at step 13. Each division may require a uniquely identifiably labeled column.

A check of the number of items is performed if the number of items is greater than one. If the number of items is greater than one then at step 14 a count of active selectable items is obtained and used to pair the items for comparison. If the number of items is not greater than one then that one item is designated as the ultimate pick. If the number of selectable items is not greater than two then only two remaining items are available for comparison and columns are not needed. As such at step 15a one selectable item is matched to the other selectable item setting up the final matchup between those two items. Consequently, no group display is needed and only one row is required.

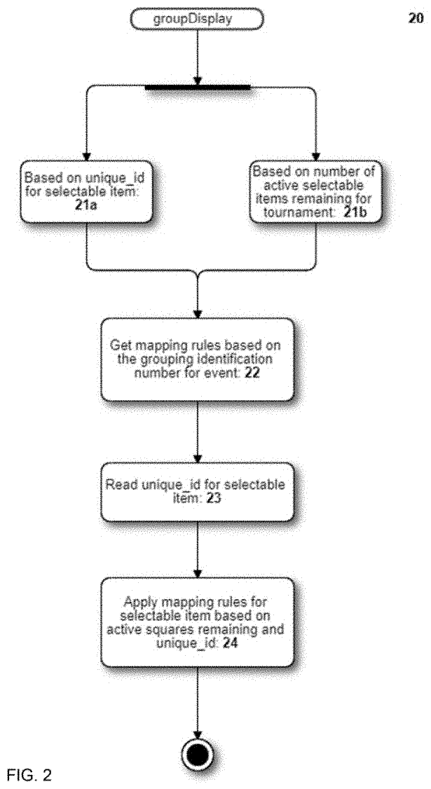

If the number of selectable items is greater than two then at step 15b selectable items are matched to other selectable items setting up a set of matchups between selectable items. These matchups may then be displayed. Process 10 then proceeds to step 16 wherein rows and columns are created for the display of matchups of comparison items and a determination is made for display within the division column. If groupDisplay is not in use at step 17 then the matchups are purely sequential: highest ranked item between item1 and item2 continues for comparison between highest ranked item of item3 and item4. If groupDisplay is in use at step 18 the process continues to process 20 as illustrated in FIG. 2.

### Group Display of Selectable Items

FIG. 2 illustrates a group display process 20 according to an embodiment. Group display process 20 allows the tournament administrator to dictate how high-ranking items are paired with other high-ranking winners within the division beyond a sequential pairing. Three parameters may be used in order to determine how the mapping is applied: a determination of the number of selectable items remaining at step 21b. This value dictates how many rows are needed to display the remaining selectable items based on how many match ups remain. Next, the mapping rules based on the grouping id, which are retrieved at step 22. Mapping rules are configurable during the creation of a tournament. They allow for compelling match ups to get to the ultimate winner and may balance the competition giving underdogs better odds, for example. Finally, the unique id for each selectable item is read at step 23. The unique id is found within the mapping rules allowing for the full path to the final matchup to be seen by the participants and dictate how future mappings are made if the selectable item unique id is the higher ranked item after a comparison at step 24.

Group Display dictates how matchups are determined. Each selectable item has a unique Id used to determine at step 21a its immediate matchup and future group matchups to becoming the sole item remaining. Display of selectable items is determined by grouping for the tournament provided as a mapping at step 21b. Round/stages/stages occur in half segments of remaining active selectable items in each iteration. For example, if 32 selectable items exist in the first stage (Round/stage/Stage 1) then the second stage (Round/stage 2) will not occur until there are only 16 active selectable items (32 items divided by 2). The next round/stage will not occur until 8 active selectable items remain, then 4, then 2 until a sole winning item remains for each Division. Once a division sole remaining item is reached, Divisional matchups may begin.

The number of rows needed for an event of this type will be provided within the mapping rules, in this case display a list of 8 selectable items or 4 rows per each of the 4 divisions. Once the number of selectable items falls to 16 or less, then active stage is incremented to Round/stage 2 and Round/stage 1 becomes a past round/stage, continuing until a sole remaining item exists. Based on the owner of the tournament's preferences, user selections/votes may be required for each Round/stage to ultimately select a winning item. Alternatively, reselections may not be available and the selections made at the beginning of the event remain and are the sole bases on which the tournament proceeds to ultimately select a winning item.

### Example A

| Round/stage 1 Layout: | After Matchup selections: |
|---|---|
| {item id: [1, 4], row: 1, group: 2}, | [4 is higher, remains active :: 1 |
| | becomes inactive] |
| {item id: [2, 3], row: 2, group: 1}, | [2 is higher, remains active :: 3 |
| | becomes inactive] |
| {item id: [5, 6], row: 3, group: 1}, | [6 is higher, remains active :: 5 |
| | becomes inactive] |
| {item id: [7, 8], row: 4, group: 2}, | [7 is higher, remains active :: 8 |
| | becomes inactive] |

Matchups are determined by layout rules that dictate the id for the selectable item, the id of the current matchup, the row to be displayed in, and the group the item belongs to. When the number of squares exceeds two rows per division, groups are needed to determine matchups for the next Round/stage within its division. For Example A, if selectable item 2 remains active after the matchup with 3 then item 2 may be pitted against the still active item after the group 1 matchup between 5, 6 since they are all in the same group.

Mapping rules allow for customizable matchups. This allows for items to initially be grouped with like pairs or potential desired matchups throughout the event. In Example A, note that 1 and 4 are initially matched rather than 1 matched with 2. These desired pairings are dictated at event creation. Once the matchups are set and user participation begins for a round/stage, matchups may not, in an embodiment, be altered. Further mapping rules may be defined in between round/stages if participation is available for each round/stage. These additional rules may not be required, as there are use cases where voting participation only at the onset would provide a more meaningful and engaging experience. In such case, the rules set out before the event are used throughout.

For the example A above, the number of rows remaining after the first round is 2 or less. For this reason, only one group is required for future matchups.

Example A

| Round/stage 2 Layout: | After Matchup: |
|---|---|
| {id: [4, 7], row: 1, group: 1}, | [4 is higher, remains active :: 7 |
| | becomes inactive] |
| {id: [2, 6], row: 2, group: 1}, | [6 is higher, remains active :: 5 |
| | becomes inactive] |

Example A

| Round/stage 3 Layout: | After Matchup: |
|---|---|
| {id: [4, 6], row: 1, group: 1}, | [4 is higher, remains active :: 6 |
| | becomes inactive] |

Example A

| Round/stage 4 Layout: | After Matchup: |
|---|---|
| {id: [4], row: 1, group: 1}, | [if id is active and only one id exists, sole |
| | division winner] |

Division winner matchups occur much like matchups within divisions.

| Division Round/stage 1 Layout: | After Divisional Matchup: |
|---|---|
| {id: [1, 2], row: 1, group: 1}, | [1 selectable item is higher, remains |
| | active :: division 2 becomes inactive] |
| {id: [3, 4], row: 1, group: 1}, | [3 selectable item is higher, remains |
| | active :: division 4 becomes inactive] |

Sole division winner from division 1 matches up against sole division winner from division 2.

| Example Round/stage 2 Layout: | After Divisional Matchup: |
|---|---|
| {id: [1, 3], row: 1, group: 1}, | [3 selectable item is higher, remains |
| | active :: division 1 becomes inactive] |
| Example Round/stage 3 Layout: | After Divisional Matchup: |
| {id: [3], row: 1, group: 1}, | [if id is active and no other active |
| | division id exists, sole event winner] |

The number of elements [ids, rows, groups, divisions, matchups and so on] are only listed here as an example and should not be considered limiting. An embodiment will support large numbers of elements through this method and is not limited in scope to those used in the example above.

### Participant Selections

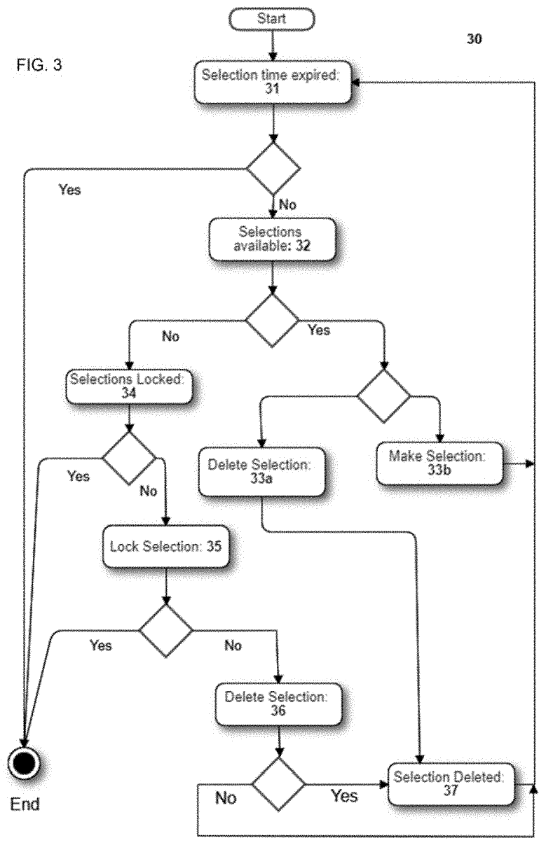

FIG. 3 illustrates participant selection according to an embodiment. Participants are allowed to make a selection as long as the tournament or event has not reached its item-selection time limit as may be determined at step 31. If the selection time has not expired, the available selections and value to be selected are made accessible to a participant at step 32 and the selection can be made at step 33b. Selections can also be deleted while remaining selections are available at step 33a. At step 34 once selections have been locked or the selection time has expired, no further selections are allowed. The participants can lock their selections at step 35 only when no remaining selections are available. If a participant has not locked the selections, and the time expiration has not been reached, the option to delete the selection remains available at step 36. Once the delete selection option is chosen, the server removes the selection from the database at step 37.

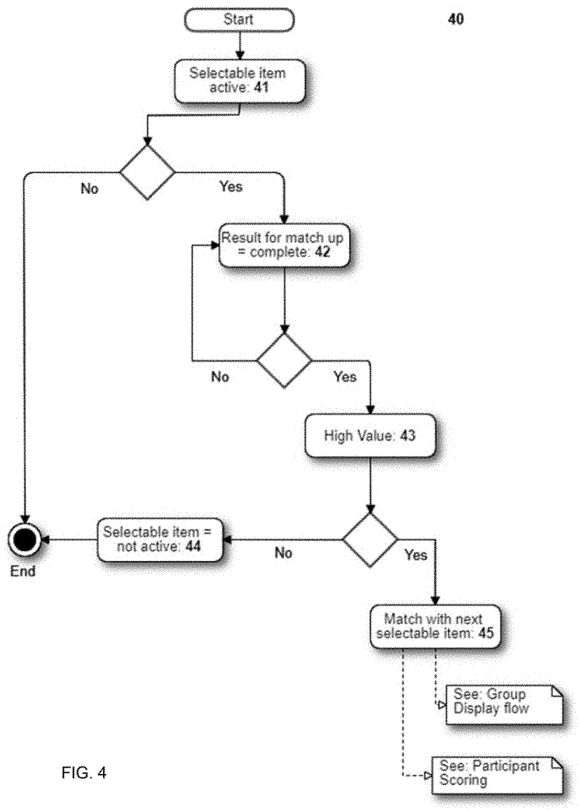

FIG. 4 illustrates a selectable item advancement process 40 according to an embodiment. At a step 41, all selectable items are set to Active at the beginning of a tournament. A matchup is complete at step 42 when time expires for the matchup or all participants have made their selection. Once either such event occurs, the total amount for each selectable item is compared with the highest total item advancing to the next round/stage/stage at step 43. The item with the smaller value is marked inactive at step 44. The item with the higher value is matched with the next selectable item at step 45. Process 40 then advances to processes 20 and 70.

### Screen Layout

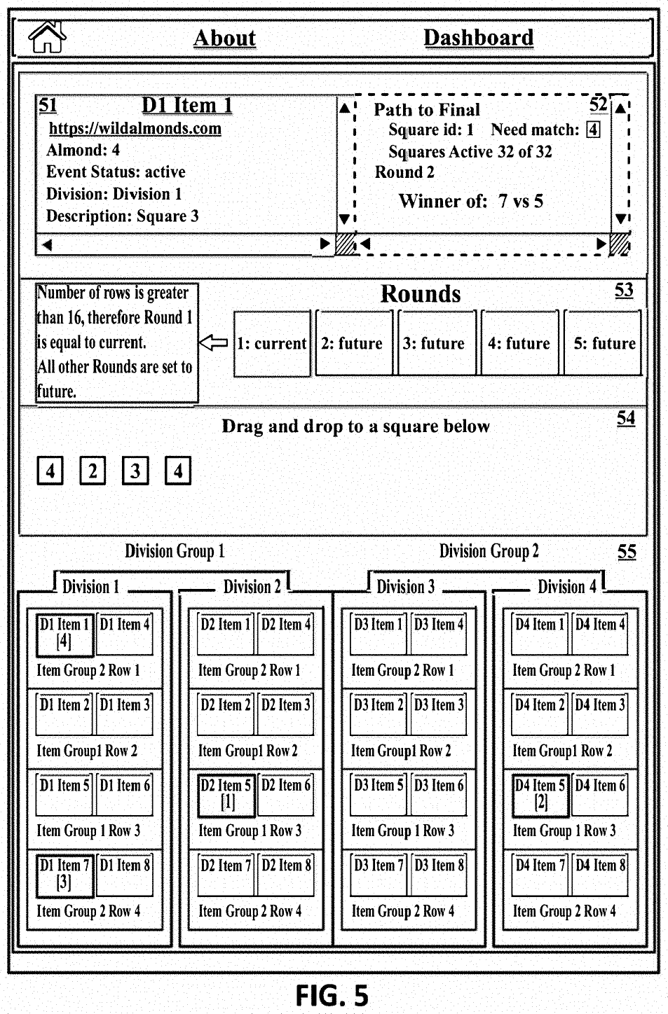

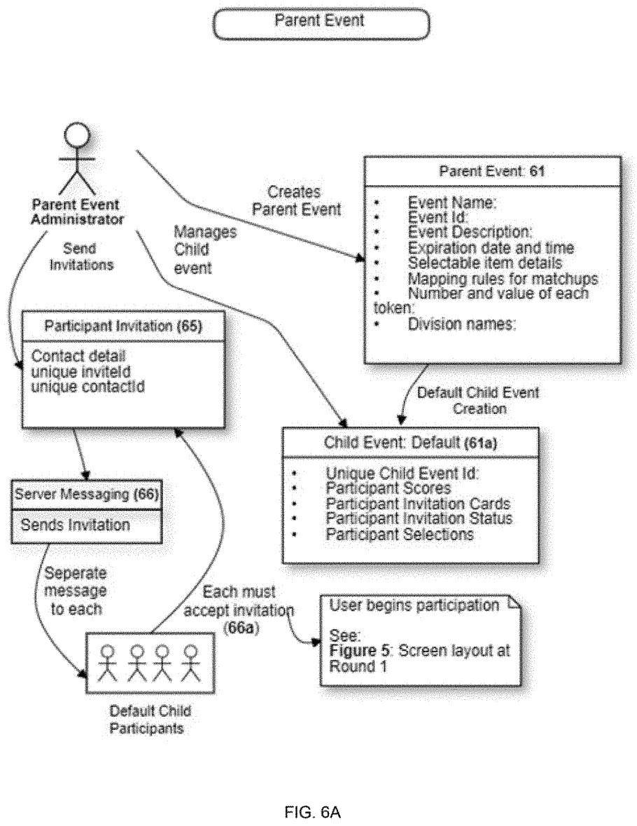

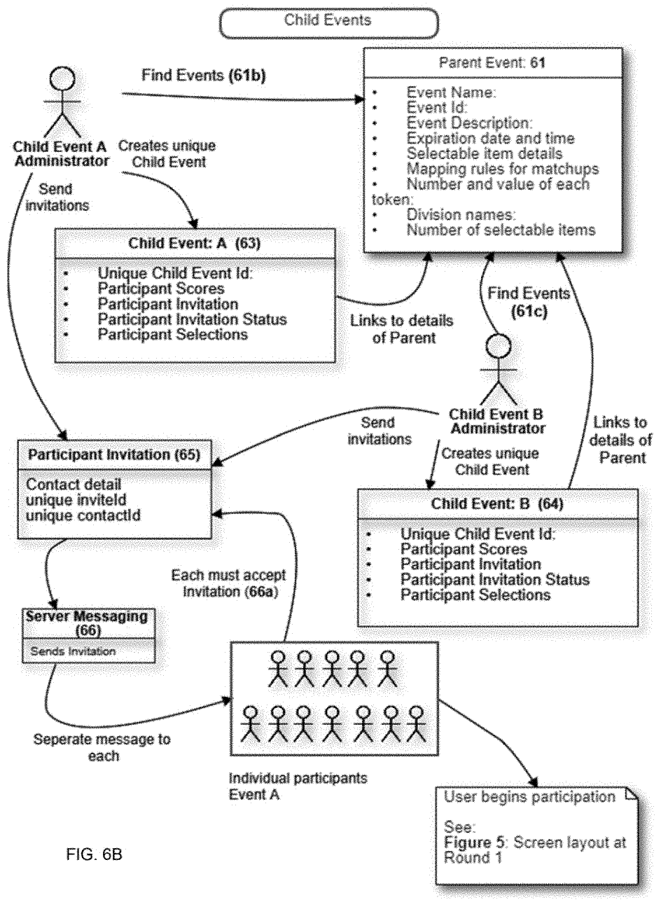

A projected layout of a 32-selectable-item event with 4 divisions is shown in FIG. 5. Details 51 about a selectable item are obtained when an icon or other indicator of the item is clicked or otherwise selected. A projected path of upcoming matchups is shown indicating the square id {1}, its next matchup {4} the number of squares active {all 32 of 32} and the next matchup should the selectable item advance {winner of 7 vs 8 which belong to group 2} 52. An embodiment calculates which round/stage is currently active by comparing the number of selectable items(squares) active to the total number that were available. In this case, 32 are still active and Round/stage 1 is the current Round/stage 53. User selections are made by dragging a ranking/scoring value 54 to a selectable item in a selectable-item grid 56. The higher the number assigned to an item, the higher the opinion of the participant concerning that item. Alternatively, the lower the number assigned to an item (i.e., the assignment of a “1” value indicates that the user regards the item as top-ranked), the higher the opinion of the participant concerning that item. In an embodiment, token values are assigned prior to participation. Token values can be sequential (Token 1=1 point, Token 2=2 points, so on) supporting point total selection or reversed order (Token 1=2 points, Token 2=1 point so on) supporting ordered preference selection. With either configuration, the higher the point value assigned to an item, the higher the opinion of the participant concerning that item. Grouping occurs the same for Divisions 55 in grid 56 as it does for selectable items in grid 56. It is not required that an item be selected from each division. As shown in the example of FIG. 5, two selections are made in Division 1, one selection in Division 2, one selection in Division 4 and no selections are made in Division 3.

### Event Creation

Referring to FIGS. 6A-6B, the ability to create child events based off tournaments (parent event) where participants compete against each other in their ability to determine an ultimate participation sole remaining item by group and tournament.

A parent event (a.k.a tournament) 61 is initially created by an administrator. Items that may be required for a parent event are
Event Name: Short descriptive name
Event Id:
Event Description: Detailed description of the parent event and the selectable items
Expiration date and time
Selectable item details (51):
Mapping rules for matchups (52):
Number and value of each token (54):
Division names (55):
Number of selectable items (56):

FIG. 6 illustrates parent/child events according to an embodiment. Each new Parent Event created spawns off a child event (a.k.a game) for the parent event owner (61a).

Child events are created from the parent by a process of search and join by a child event administrator (61b and 61c). Child administrators create a uniquely identifiable event which they administer (63 and 64). After creation of the child event, they can add Participants via electronic invitation (65) sent by the system (66). Each individual must accept an invitation to join the event (66a). User participation and scoring is local to that event group as well as the parent scoring (61a, 63 and 64).

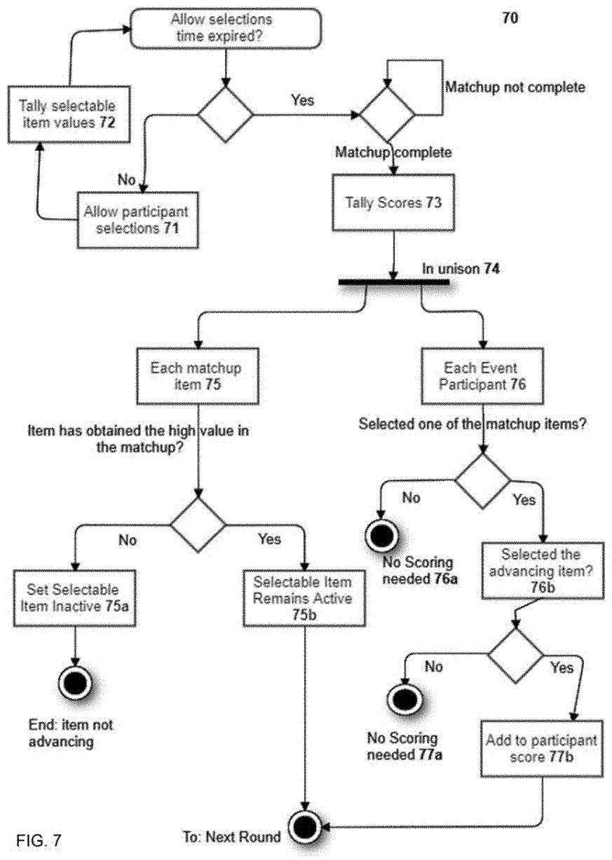

FIG. 7 illustrates scoring according to an embodiment.

### For Selectable Items

Participants assign a value 54 (as defined in (61): Number and value of each token) to the selectable item 56 as part of their participation at a step 71. Each value 54 assigned to the item is stored and tallied at a step 72. After the time for selections has expired and the matchup has been completed, the scores are again tallied at step 73. The selectable item 75 with the most points awarded to it as compared to its matchup, and as discussed with reference to process 40, advances through the round/stages/stages at step 75b. Items with a low score do not advance to new round/stages/stages as shown at step 75a.

### For Participants

A score is defined when a selectable item advances to the next round/stage/stage at step 76b. The value of the token they have assigned to the advancing selectable item is added to their overall score at the end of each matchup at step 77b. Highest score, or, alternatively, lowest score if the ranking approach is used, within the group is the group winner both in terms of selectable item and participant that predicted the outcome. The alternative high/low score approaches will henceforth be referred to as “best” score.

The best total group score, also both in terms of selectable item and participant are the parent group winners. The best participant score for any group is the overall parent event winner. Where two selectable items or two participants end with an equal score resulting in a tie, resolution may be made by assigning random numbers to both items with, for example, the highest random number determining the winner.

One or more embodiments include a system and method for reducing a large quantity of selectable items to an ultimate item and participant winner. In particular displaying selectable items within divisions and grouping items against each other within each division with the best-rated object progressing. Groups may be used to pair selectable item winners within a division beyond the default sequential display. Child events (a.k.a games) are child objects of the parent event (a.k.a tournament). Participants join events and points are allocated to items by event participants as a selection prior to a tournament expiration time. Once the final comparison result (matchup) is achieved, the number of points the participant has allocated to the advancing item is awarded to the participant. All selectable items are compared to each other via mapping rules, both within divisions and until there is a division sole remaining item. Next, matchups occur across divisions per division mapping rules. Finally, the last remaining selectable item is declared the ultimate tournament winner. When an ultimate selectable item winner is determined, the participant within each child event who has acquired the most points is declared the winner of the child event. In the case of a tie, a random numerical value is assigned as a tie break. This child event participant with the best point total is the child event winner. The child event winner with the best score among all groups is the parent event winner. The last remaining selectable item is declared the parent event selectable item winner.

One or more embodiments of the invention may include the following features:
The layout of selectable items within a division and the progression of the highest scored items through a system of rating, scoring, or judging removing the lesser item until one selectable remains (10).
The creation of parent and child events including the point selections, selectable items, sending of invitations to participants (60).
The method to create custom groupings within the divisions for further matchups of active selectable items (Example A, 55 & 56).
Participant ability to select an item by moving a point selection token to selectable item. (40, 54).
Ability to progress matchup high ranking item with new comparison item through round/stages (20, 53).
Display of description of selectable item after interaction (mouse click or touch) (51).
Display of future path to the ultimate sole remaining item prior to selection for a selectable item (52).
Scoring of a selectable item and participants ability to predict outcome of selectable item matchups (70).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. At least one computer-readable medium on which are stored instructions that, when executed by at least one processing device, enable the at least one processing device to perform a method of conducting a contest, the method comprising the steps of:
compiling identifiers of a first set of multiple items, each said item of the first set having at least one characteristic different from each other item of the first set;
making a graphical user interface (GUI) available to display devices of multiple user participants, the GUI including the identifiers of the multiple items;
receiving from each of the user participants via the GUI an indication of the preference of each user participant for an item of the first set; and
tallying the user indications to determine a first subset of one or more victorious set items of a first round of the contest, the first subset containing fewer items than does the first set.

2. The medium of claim 1, wherein if the first subset contains multiple victorious set items of the first round, the method further comprises the step of tallying the user indications of the items of the first subset to determine a second subset of one or more victorious set items of a second round of the contest, the second subset containing fewer items than does the first subset.

3. The medium of claim 1, wherein if the first subset contains multiple victorious set items of the first round, the method further comprises the steps of:
making the graphical user interface (GUI) available to display devices of multiple user participants, the GUI including the identifiers of the items of the first subset;
receiving from each of the user participants via the GUI an indication of the preference of each user participant for an item of the first subset; and
tallying the user indications of the items of the first subset to determine a second subset of one or more victorious set items of a second round of the contest, the second subset containing fewer items than does the first subset.

4. The medium of claim 1, wherein each indication of preference indicates a preference over only a single other item.

5. The medium of claim 1, wherein each of the user participants via the GUI provide multiple indications of preference of each user participant for respective multiple items of the first set.

6. The medium of claim 5, wherein the indications of preference comprise numerical values indicating a degree of respective preference.

7. The medium of claim 1, wherein the items are wines.

8. The medium of claim 7, wherein the at least one characteristic is wine brand.

9. A method of conducting a contest, the method comprising the steps of:
compiling identifiers of a first set of multiple items, each said item of the first set having at least one characteristic different from each other item of the first set;
making a graphical user interface (GUI) available to display devices of multiple user participants, the GUI including the identifiers of the multiple items;
receiving from each of the user participants via the GUI an indication of the preference of each user participant for an item of the first set; and
tallying the user indications to determine a first subset of one or more victorious set items of a first round of the contest, the first subset containing fewer items than does the first set.

10. The method of claim 9, wherein if the first subset contains multiple victorious set items of the first round, the method further comprises the step of tallying the user indications of the items of the first subset to determine a second subset of one or more victorious set items of a second round of the contest, the second subset containing fewer items than does the first subset.

11. The method of claim 9, wherein if the first subset contains multiple victorious set items of the first round, the method further comprises the steps of:
making the graphical user interface (GUI) available to display devices of multiple user participants, the GUI including the identifiers of the items of the first subset;
receiving from each of the user participants via the GUI an indication of the preference of each user participant for an item of the first subset; and
tallying the user indications of the items of the first subset to determine a second subset of one or more victorious set items of a second round of the contest, the second subset containing fewer items than does the first subset.

12. The method of claim 9, wherein each indication of preference indicates a preference over only a single other item.

13. The method of claim 9, wherein each of the user participants via the GUI provide multiple indications of preference of each user participant for respective multiple items of the first set.

14. The method of claim 13, wherein the indications of preference comprise numerical values indicating a degree of respective preference.

15. The method of claim 9, wherein the items are wines.

16. The method of claim 15, wherein the at least one characteristic is wine brand.
